(19) United States
(12) Patent Application Publication
(10) Pub. No.: US 2015/0277717 A1
(43) Pub. Date: Oct. 1, 2015

(54) INTERACTIVE INPUT SYSTEM AND METHOD FOR GROUPING GRAPHICAL OBJECTS

(71) Applicant: SMART Technologies ULC, Calgary (CA)

(72) Inventors: KEVIN BARABASH, Calgary (CA); MICHAEL ROUNDING, Calgary (CA); CHRIS CHAN, Calgary (CA); CLINTON LAM, Calgary (CA); NICOLE PERCIVAL, Calgary (CA); BONNIE PRESSER, Calgary (CA)

(21) Appl. No.: 14/668,460

(22) Filed: Mar. 25, 2015

Related U.S. Application Data
(60) Provisional application No. 61/971,786, filed on Mar. 28, 2014.

(51) Int. Cl. G06F 3/0484; G06F 3/01

(52) U.S. Cl. CPC G06F 3/04845; G06F 3/04847; G06F 3/04842; G06F 3/017

(57) ABSTRACT

A method for grouping graphical objects, comprises presenting graphical objects on a display surface and in the event that the graphical objects at least partially overlap, grouping the graphical objects.

### CROSS-REFERENCE TO RELATED APPLICATION

This application claims the benefit of U.S. Provisional Application No. 61/971,786 to Barabash et al. filed on Mar. 28, 2014, the entire content of which is incorporated herein by reference.

### FIELD

This application relates generally to interactive input systems and in particular, to an interactive input system and method for grouping graphical objects.

### BACKGROUND

Interactive input systems that allow users to inject input such as for example digital ink, mouse events etc. into an application program using an active pointer (eg. a pointer that emits light, sound or other signal), a passive pointer (eg. a finger, cylinder or other object) or other suitable input device, such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the disclosures of which are incorporated by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are then conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Improvements in interactive input systems are desired. It is therefore an object to provide a novel interactive input system and method for grouping graphical objects.

### SUMMARY

Accordingly, in one aspect there is provided a method for grouping graphical objects, comprising presenting graphical objects on a display surface; and in the event that the graphical objects at least partially overlap, grouping the graphical objects.

In some embodiments, during the grouping, the graphical objects are grouped according to a defined hierarchy. The step of grouping may comprise identifying one of the graphical objects as a parent graphical object, and identifying each other graphical object as a child graphical object associated with the parent graphical object. The method may further comprise manipulating one or more of the graphical objects. Manipulating the graphical objects may be performed in response to a gesture performed on the interactive surface. In the event the gesture is performed on the display surface at a location associated with the parent graphical object, the parent graphical object and child graphical object are manipulated according to the gesture. In the event that the gesture is performed on the display surface at a location associated with the child graphical object, only the child graphical object is manipulated according to the gesture. Each graphical object may comprise an event handler configured to receive gesture data generated in response to the performed gesture and to manipulate the respective graphical object based on the received gesture data.

The parent graphical object and each child graphical object may be identified based on relationship criteria such as stacking order, graphical object size and/or graphical object type. For example, when the relationship criteria is stacking order, the graphical object at the bottom of a stack may be identified as the parent graphical object with each child graphical object at least partially overlying the parent graphical object. When the relationship criteria is graphical object size, the largest graphical object may be identified as the parent graphical object with each child graphical object being smaller than the parent graphical object. When the relationship criteria is graphical object type, a first type of graphical object may be identified as the parent graphical object with each child graphical object being a different type of graphical object.

According to another aspect there is provided a non-transitory computer readable medium having stored thereon computer program code, which when executed by a computing device, performs a method comprising: presenting graphical objects on a display surface; and in the event that the graphical objects at least partially overlap, grouping the graphical objects.

According to another aspect there is provided an interactive input system comprising an interactive surface; and processing structure communicating with the interactive surface and configured to cause graphical objects to be displayed on the interactive surface; and in the event that the graphical objects at least partially overlap, group the graphical objects.

According to another aspect there is provided an apparatus comprising one or more processors; and memory storing program code, the one or more processors communicating with said memory and configured to execute the program code to cause said apparatus at least to cause graphical objects to be displayed on an interactive surface; and in the event that the graphical objects at least partially overlap, group the graphical objects.

### BRIEF DESCRIPTION OF THE DRAWINGS

Embodiments will now be described more fully with reference to the accompanying drawings in which:

FIG. 1a is a perspective view of an interactive input system in the form of a touch table;

FIG. 1b is a side sectional view of the interactive input system of FIG. 1a;

FIG. 1c is a side sectional view of a table top and touch panel forming part of the interactive input system of FIG. 1a;

FIG. 2 illustrates a finger in contact with the touch panel forming part of the interactive input system of FIG. 1a;

FIG. 3 is a block diagram illustrating the software structure of a host application running on the interactive input system of FIG. 1a;

FIG. 4 is a flowchart showing steps performed by a Contact Event Monitor forming part of the host application;

FIG. 5 shows an example of graphical objects grouped according to a defined hierarchy and defining a parent graphical object and a child graphical object;

FIG. 6 shows an example of manipulating the parent graphical object and the child graphical object of FIG. 5 based on an input movement gesture;

FIG. 7 shows an example of manipulating the child graphical object of FIG. 5 based on an input movement gesture;

FIG. 8 shows an example of ungrouping the parent graphical object and the child graphical object of FIG. 5;

FIG. 9 shows another example of grouping the graphical objects of FIG. 5 based on another input movement gesture;

FIG. 10 shows an example of grouping the graphical objects of FIG. 5 based on an input throwing gesture;

FIG. 11 shows another example of graphical objects grouped according to a defined hierarchy; and

FIG. 12 shows another example of graphical objects grouped according to a defined hierarchy.

### DETAILED DESCRIPTION OF EMBODIMENTS

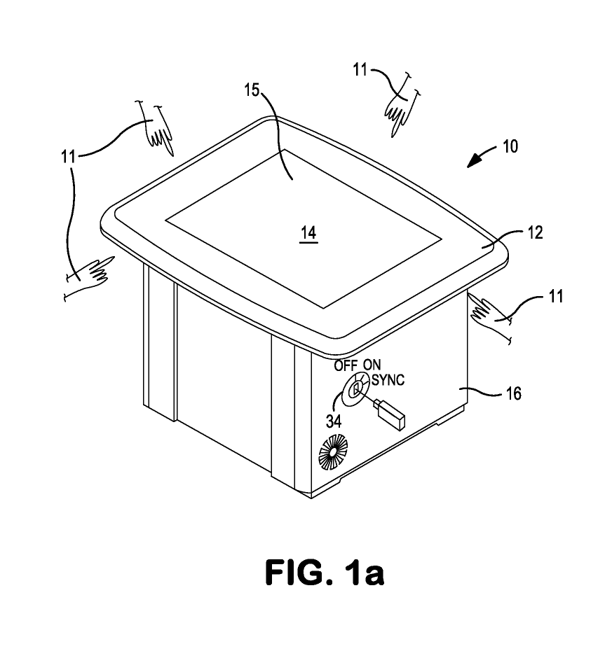

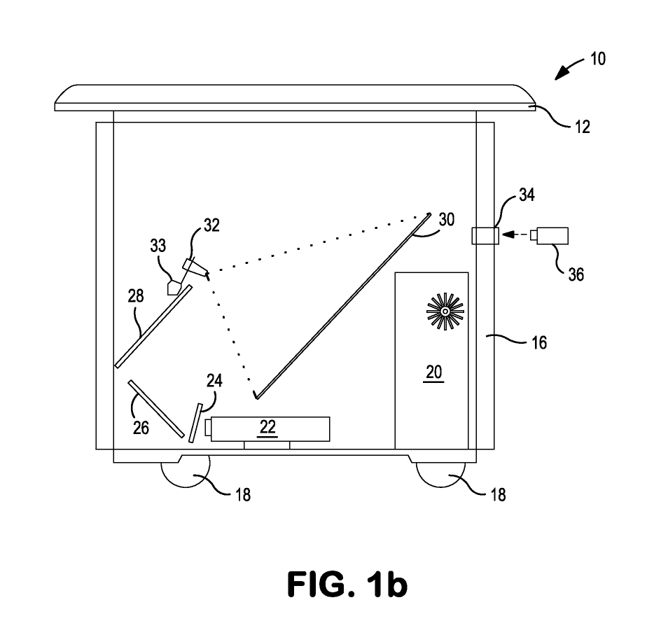

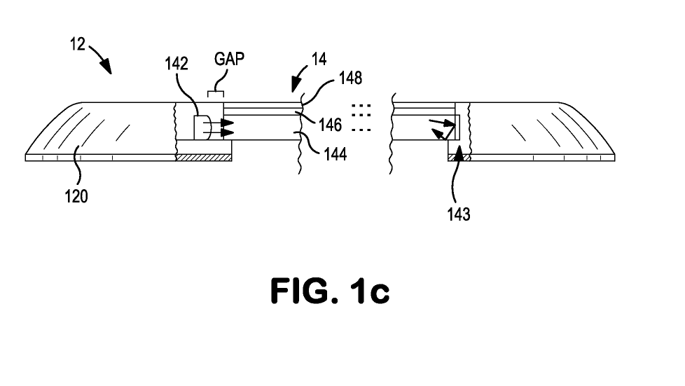

Turning now to FIGS. 1a and 1b, an interactive input system in the form of a touch table is shown and is generally identified by reference numeral 10. Touch table 10 comprises a table top 12 mounted atop and supported by a cabinet 16. In this embodiment, cabinet 16 sits atop wheels 18 that enable the touch table 10 to be easily moved from place to place in a classroom or other environment in which the touch table 10 is located. Integrated into table top 12 is a coordinate input device or interactive surface in the form of a frustrated total internal reflection (FTIR) based touch panel 14 that enables detection and tracking of one or more pointers 11, such as fingers, pens, hands, cylinders, or other objects, brought into contact with the touch panel 14, as will be described.

Cabinet 16 houses processing structure 20 executing a host application and one or more application programs. The cabinet 16 also houses a projector 22, an infrared (IR) filter 24, and mirrors 26, 28 and 30. In this embodiment, projector 22 is oriented horizontally in order to preserve projector bulb life, as commonly-available projectors are typically designed for horizontal placement. Image data generated by the processing structure 20 is conveyed to the projector 22, which in turn projects a corresponding image that passes through the infrared filter 24, reflects off of the mirrors 26, 28 and 30 and impinges on a display surface 15 of the touch panel 14 allowing the projected image to be visible to a user looking downwardly onto the touch table 10. As a result, the user is able to interact with the displayed image via pointer contacts on the display surface 15. The mirrors 26, 28 and 30 function to “fold” the image projected by projector 22 within cabinet 16 along a light path without unduly sacrificing image size allowing the overall dimensions of the touch table 10 to be reduced.

An imaging device 32 in the form of an IR-detecting camera is also housed within the cabinet 16 and is mounted on a bracket 33 adjacent mirror 28 at a position such that it does not interfere with the light path of the image projected by projector 22. The imaging device 32, which captures image frames at intervals, is aimed at mirror 30 and thus, sees a reflection of the display surface 15 in order to mitigate the appearance of hotspot noise in captured image frames that typically must be dealt with in systems having imaging devices that are aimed directly at the display surface.

The processing structure 20 communicates with the imaging device 32 and processes captured image frames to detect pointer contacts on the display surface 15. Detected pointer contacts are used by the processing structure 20 to update image data provided to the projector 22, if necessary, so that the image displayed on the display surface 15 reflects the pointer activity. In this manner, pointer interactions with the display surface 15 can be recorded as handwriting or drawing or used to control execution of application programs.

The processing structure 20 in this embodiment is a general purpose computing device in the form of a computer. The computer comprises for example, a processing unit comprising one or more processors, system memory (volatile and/or non-volatile memory), other non-removable or removable memory (a hard disk drive, RAM, ROM, EEPROM, CD-ROM, DVD, flash memory etc.) and a system bus coupling the various computer components to the processing unit. Execution of the host software application by the processing structure 20 results in a graphical user interface comprising a background page or palette, upon which graphical objects are displayed, being projected on the display surface 15. The graphical user interface allows freeform or handwritten ink to be input and/or manipulated via pointer interaction with the display surface 15.

An external data port/switch 34, in this embodiment a universal serial bus (USB) port/switch, extends from the interior of the cabinet 16 through the cabinet wall to the exterior of the touch table 10 providing access for insertion and removal of a USB key 36, as well as switching of functions. A power supply (not shown) supplies electrical power to various components of the touch table 10. The power supply may be an external unit or, for example, a universal power supply within the cabinet 16 for improving portability of the touch table 10. The cabinet 16 fully encloses its contents in order to restrict the levels of ambient visible and infrared light entering the cabinet 16 thereby to yield satisfactory signal to noise performance. Provision is made for the flow of air into and out of the cabinet 16 for managing the heat generated by the various components housed inside the cabinet 16, as disclosed in U.S. Patent Application Publication No. 2010/0079409 entitled “TOUCH PANEL FOR AN INTERACTIVE INPUT SYSTEM AND INTERACTIVE INPUT SYSTEM INCORPORATING THE TOUCH PANEL” to Sirotich et al., assigned to the assignee of the subject application, the relevant portions of the disclosure of which are incorporated herein by reference.

FIG. 1c better illustrates the table top 12 and as can be seen, table top 12 comprises a frame 120 supporting the touch panel 14. In this embodiment, frame 120 is composed of plastic or other suitable material. As mentioned above, the touch panel 14 operates based on the principles of frustrated total internal reflection (FTIR), as disclosed in the above-incorporated U.S. Patent Application Publication No. 2010/0079409. Touch panel 14 comprises an optical waveguide layer 144 that, according to this embodiment, is a sheet of acrylic. A resilient diffusion layer 146 lies against the upper surface of the optical waveguide layer 144. The diffusion layer 146 substantially reflects IR light escaping the optical waveguide layer 144 down into the cabinet 16, and diffuses visible light projected onto it by the projector 22 in order to display the projected image and act as the display surface 15. Overlying the resilient diffusion layer 146 on the opposite side of the optical waveguide layer 144 is a clear, protective layer 148 having a smooth touch surface. While the touch panel 14 may function without the protective layer 148, the protective layer 148 provides a surface that permits use of the touch panel 14 without undue discoloration, snagging or creasing of the underlying diffusion layer 146, and without undue wear on users' fingers. Furthermore, the protective layer 148 provides abrasion, scratch and chemical resistance to the overall touch panel 14, as is useful for touch panel longevity. The protective layer 148, diffusion layer 146, and optical waveguide layer 144 are clamped together at their edges as a unit and mounted within the frame 120. Over time, prolonged use may wear one or more of the layers. As desired, the edges of the layers may be unclamped in order to inexpensively allow worn layers to be replaced. It will however, be understood that the layers may be held together in other ways, such as by use of one or more of adhesives, friction fit, screws, nails, or other suitable fastening methods.

A bank of illumination sources such as infrared light emitting diodes (LEDs) 142 is positioned along at least one side surface of the optical waveguide layer 144 (into the page in FIG. 1c). Each LED 142 emits IR light that enters and propagates within the optical waveguide layer 144. Bonded to the other side surfaces of the optical waveguide layer 144 is reflective tape 143 to reflect IR light impinging thereon back into the optical waveguide layer 144 thereby trapping the propagating IR light in the optical waveguide layer 144 and saturating the optical waveguide layer 144 with IR illumination.

When a user contacts the touch panel 14 with a pointer 11, the pressure of the pointer 11 against the protective layer 148 compresses the resilient diffusion layer 146 against the optical waveguide layer 144, causing the index of refraction of the optical waveguide layer 144 at the contact point of the pointer 11, or “touch point”, to change. This change in the index of refraction “frustrates” the total internal reflection at the touch point causing IR light to reflect at an angle that allows it to escape from the optical waveguide layer 144 at the touch point in a direction generally perpendicular to the plane of the optical waveguide layer 144. The escaping IR light reflects off of the pointer 11 and scatters locally downward through the optical waveguide layer 144 and exits the optical waveguide layer 144 through its bottom surface. This occurs for each pointer 11 contacting the display surface 15. As each pointer 11 is moved along the display surface 15, the compression of the resilient diffusion layer 146 against the optical waveguide layer 144 occurs and thus, escaping IR light tracks the pointer movement.

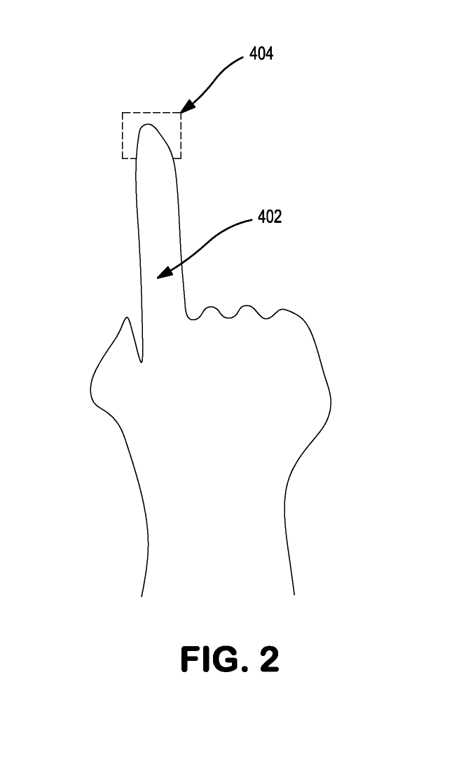

As mentioned above, imaging device 32 is aimed at the mirror 30 and captures IR image frames. Because IR light is filtered from the images projected by projector 22 by infrared filter 24, in combination with the fact that cabinet 16 substantially inhibits ambient light from entering the interior of the cabinet, when no pointer contacts are made on the touch panel 14, the captured image frames are dark or black. When the touch panel 14 is contacted by one or more pointers as described above, the image frames captured by imaging device 32 comprise one or more bright points corresponding to respective touch points on a dark or black background. The processing structure 20, which receives the captured image frames, processes the image frames to calculate the coordinates and characteristics of the one or more bright points corresponding to respective touch points. The touch point coordinates are then mapped to the display coordinates and resulting touch point data is generated. As illustrated in FIG. 2, each touch point in this embodiment is characterized as a rectangular touch area 404 having a center position (X,Y), a width W and a height H such that the touch area 404 approximates the position and the size of the pointer tip in contact with the display surface 15 of the touch panel 14.

The host application receives the touch point data and based on the touch point data determines whether to register a new touch point, modify an existing touch point, or cancel/delete an existing touch point. In particular, the host application registers a Contact Down event representing a new touch point when it receives touch point data that is not related to an existing touch point or that represents the first touch point appearing in a captured image frame, and accords the new touch point a unique identifier. Touch point data may be considered unrelated to an existing touch point if the touch point data is associated with a touch point that is a threshold distance away from any existing touch point, for example. The host application registers a Contact Move event representing movement of a touch point when it receives touch point data that is related to an existing touch point, for example by being within a threshold distance of, or overlapping an existing touch point. When a Contact Move event is generated, the center position (X,Y) of the touch point is updated. The host application registers a Contact Up event representing removal of a touch point when touch point data associated with a previously existing touch point is no longer generated. Generated contact events are monitored and processed to determine if the contact events represent an input gesture. If not, the contact events are processed in a conventional manner. If the contact events represent an input gesture, corresponding gesture data that includes the contact events is generated and processed as will now be described.

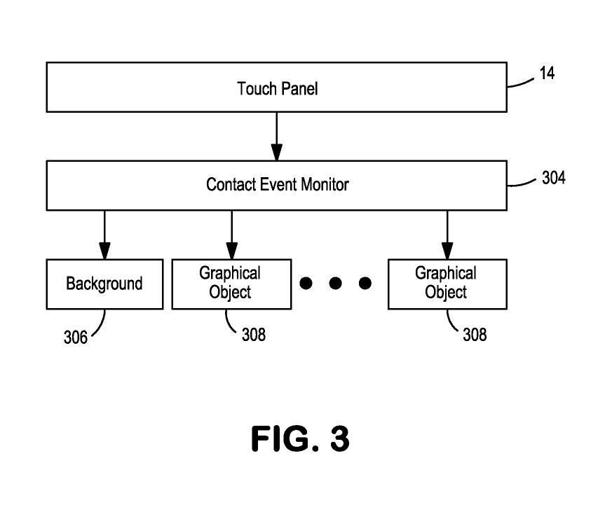

FIG. 3 is a block diagram illustrating the software structure of the host application running on the processing structure 20. As can be seen, the host application comprises a Contact Event Monitor 304 that receives and tracks touch point data. The touch point data for each touch point comprises touch point coordinates and a unique contact ID, as disclosed in U.S. Patent Application Publication No. 2010/0079385 entitled “METHOD FOR CALIBRATING AN INTERACTIVE INPUT SYSTEM AND INTERACTIVE INPUT SYSTEM EXECUTING THE METHOD” to Holmgren et al., assigned to the assignee of the subject application, the relevant portions of the disclosure of which are incorporated herein by reference. The Contact Event Monitor 304 processes the received touch point data and based on the touch point data, generates a contact event for each touch point. The contact events are then processed to identify or recognize gestures performed by the user.

When a gesture is recognized, the Contact Event Monitor 304 passes the gesture data in real-time as an argument either to a graphical object 308 or to the background 306 for processing. Based on the processing, the image data output by the processing structure 20 that is conveyed to the projector 22 is updated so that the image presented on the display surface 15 reflects the results of the gesture. The gesture data that is processed may be used to manipulate the graphical object 308. For example, the user may perform a gesture to move the graphical object 308, scale the graphical object 308, rotate the graphical object 308 or delete the graphical object 308. In this manner, users are able to smoothly select and manipulate the background 306 and/or graphical objects 308 displayed on the display surface 15.

The background 306 and graphical objects 308 encapsulate functions whose input arguments include gesture data. In this embodiment, each graphical object 308 comprises an event handler, which processes received gesture data to manipulate the graphical object 308. When a graphical object 308 is displayed on the display surface 15 of the touch panel 14 and a gesture that is associated with the graphical object is identified, gesture data is communicated to the event handler of the graphical object and processed and as a result the graphical object is manipulated based on the identified gesture. In this embodiment, movement or throwing gestures may be used to move the graphical object 308, pinch-in and pinch-out gestures may be used to scale the graphical object 308, a rotate gesture may be used to rotate the graphical object 308 and a circle-and-tap gesture may be used to delete the graphical object 308.

If a single Contact Down event is generated at a location corresponding to a graphical object 308, followed by one or more Contact Move events and then a single Contact Up event, the gesture is identified as either a movement gesture or a throwing gesture. If the touch point travels more than a threshold distance in a relatively straight line, and the time between the Contact Down and Contact Up events is less than a threshold time, the gesture is identified as the throwing gesture. Identification of the throwing gesture results in movement of the graphical object 308 based on the speed of the throwing gesture. If the distances between touch point center positions (X,Y) of the Contact Move events are less than a threshold distance, the gesture is identified as the movement gesture. Identification of the movement gesture results in movement of the graphical object 308, starting at the position of the Contact Down event and ending at the position of the Contact Up event.

If more than one Contact Down event is generated at a location corresponding to a graphical object 308, followed by more than one Contact Move event and more than one Contact Up event, the gesture is identified as either a pinch-in gesture, a pinch-out gesture or a rotation gesture, depending on the Contact Move events. If the touch points are moving towards one another, the gesture is identified as the pinch-in gesture. Identification of the pinch-in gesture results in the size of the graphical object 308 being reduced. If the touch points are moving away from one another, the gesture is identified as the pinch-out gesture. Identification of the pinch-out gesture results in the size of the graphical object 308 being increased. If one or more of the touch points is moving in a generally circular direction, the gesture is identified as the rotate gesture. Identification of the rotate gesture results in rotation of the graphical object 308.

If at least one Contact Down event is generated at a location corresponding to the background 306, followed by more than one Contact Move event and at least one Contact Up event, the Contact Move events are monitored. If one or more of the touch points moves in a generally circular direction around a region containing a graphical object 308, followed by a Contact Down event within the region, the circle-and-tap gesture is identified. In this embodiment, identification of the circle-and-tap gesture results in the graphical object 308 being erased or deleted.

In the event that two or more graphical objects are displayed on the display surface 15 of the touch panel 14 and a gesture is identified, gesture data is communicated to the event handler of one or more of the graphical objects, depending on whether the graphical objects are grouped. In this embodiment, a group is defined as having a parent graphical object and at least one child graphical object.

The Contact Event Monitor 304 comprises a grouping module that monitors the groupings of displayed graphical objects. For each graphical object, the grouping module contains a group indicator representing the group to which the graphical object belongs, and a status indicator indicating the status of the graphical object within the group. For example, if a graphical object belongs to “group 1” and is the parent graphical object of the group, the group indicator is set as “1” and the status indicator is set as “P”. If a graphical object belongs to “group 1” and is a child graphical object of the group, the group indicator is set as “1” and a status indicator is set as “C”. If the graphical object is not part of a group, a default value of ‘0’ is used for both the group indicator and the status indicator.

When a gesture is performed that is associated with a graphical object of a group, the resulting gesture data is handled in a manner that is dependent on whether the gesture is considered to originate with the parent graphical object of the group or a child graphical object of the group. In particular, if the gesture originates with the parent graphical object of the group, the resulting gesture data is communicated to the event handler of the parent graphical object and to the event handler of each child graphical object of the group resulting in manipulation of the parent graphical object and each child graphical object. In contrast, if the gesture originates with a child graphical object, the resulting gesture data is communicated to the event handler of the child graphical object resulting in manipulation of the child graphical object, that is, the parent graphical object is not manipulated. For example, in the event that the Contact Event Monitor 304 identifies a movement gesture on the parent graphical object of group 1, the movement gesture data is passed to the event handler of the parent graphical object of group 1 and to the event handlers of all child graphical objects of group 1. In the event that the Contact Event Monitor 304 identifies a movement gesture on a graphical object that is a child graphical object of group 1, the movement gesture data is only passed to the event handler of that particular child graphical object.

In this embodiment, a group is created in the event that a graphical object overlaps with at least a portion of another graphical object. In the following, a gesture described as being performed on the parent graphical object means that the gesture is performed at any location on the parent graphical object that does not overlap with the child graphical object. If a graphical object overlaps with a portion of another graphical object and thus, the graphical objects are to be grouped, the parent graphical object and child graphical object are identified based on relationship criteria. In this embodiment, the relationship criteria is based on stacking order, that is, the graphical object at the bottom is set as the parent graphical object and each graphical object overlying the parent graphical object is set as a child graphical object. As will be appreciated, a parent graphical object may have multiple child graphical objects associated therewith. In contrast, a child graphical object may only have one parent graphical object.

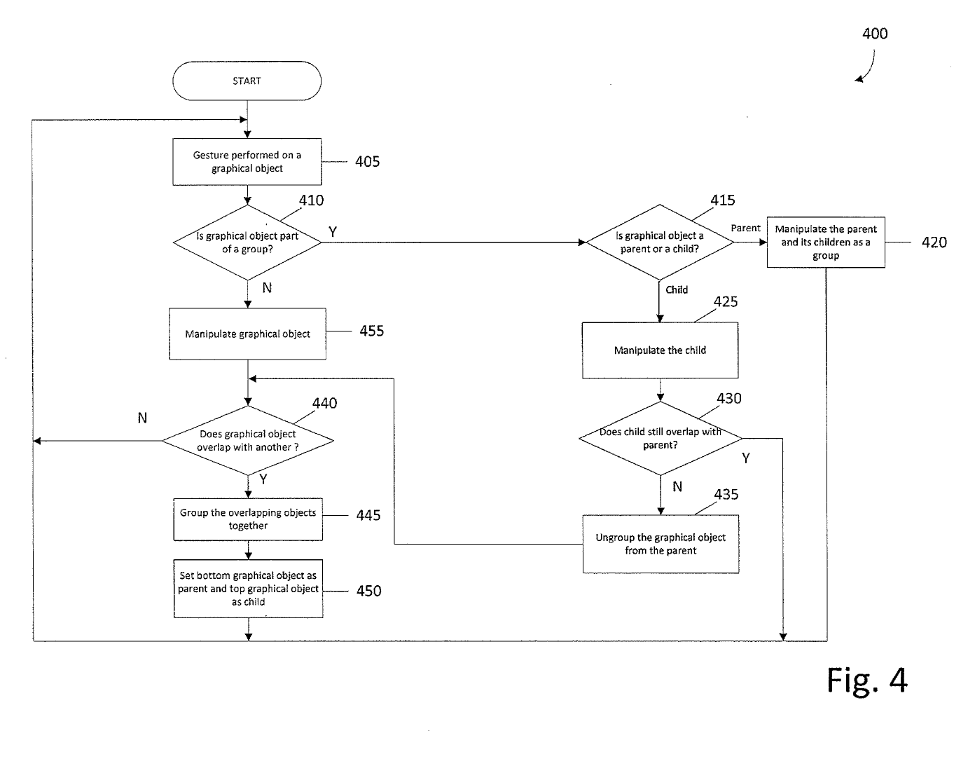

A flowchart illustrating a method 400 performed by the Contact Event Monitor is shown in FIG. 4. The method begins in the event a gesture is performed on the display surface 15 of the touch panel 14 at a position associated with a graphical object (step 405). A check is then performed to determine if the graphical object is part of a group (step 410). If the graphical object is part of a group, a check is performed to determine if the graphical object is a parent graphical object or a child graphical object (step 415). If the graphical object is a parent graphical object, the gesture data is sent to the event handlers of the parent and child graphical objects of the group. As a result, the parent and child graphical objects are manipulated as a group according to the performed gesture (step 420) and the method returns to step 405. If, at step 415, the graphical object is a child graphical object, the gesture data is sent to the event handler of the child graphical object and as a result only the child graphical object is manipulated according to the performed gesture (step 425). A check is then performed to determine if the child graphical object still overlaps with at least a portion of the parent graphical object (step 430) and if so, the method returns to step 405. If, at step 430, the child graphical object does not overlap with at least a portion of its parent graphical object, the child graphical object is ungrouped from its parent graphical object (step 435). A check is then performed to determine if the graphical object overlaps with at least a portion of another graphical object (step 440). In this embodiment, to determine if the graphical object overlaps with at least a portion of another graphical object, the borders of each graphical object are used, regardless of whether they are visible or not. If the graphical object overlaps with at least a portion of another graphical object, the graphical objects are grouped (step 445) such that the bottom graphical object is set as the parent graphical object and the overlying top graphical object is set as the child graphical object (step 450). If, at step 440, the graphical object does not overlap with at least a portion of another graphical object, the method returns to step 405.

If, at step 410, the graphical object is not part of a group, the gesture data is sent to the event handler of the graphical object and as a result the graphical object is manipulated according to the gesture (step 455). The method then continues to step 440 to determine if the graphical object overlaps with at least a portion of another graphical object, as described above.

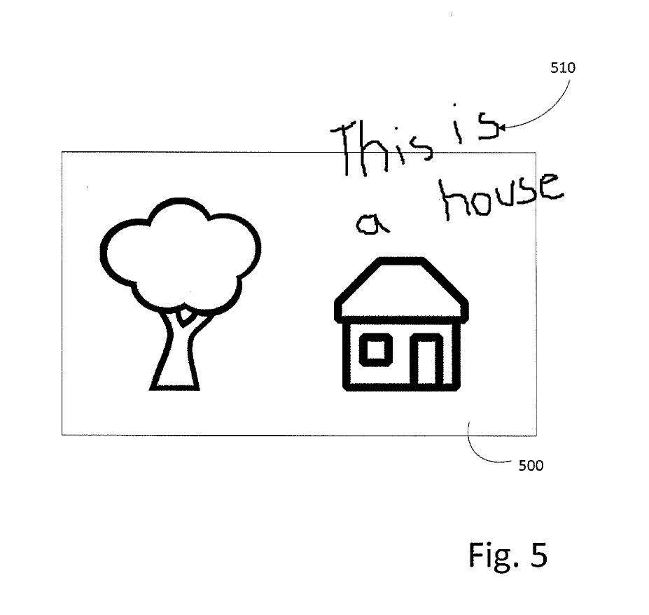

Turning now to FIG. 5 an example of method 400 is shown. As can be seen, first and second graphical objects 500 and 510, respectively, are displayed on the display surface 15 of the touch panel 14. In this embodiment, the first graphical object 500 is a picture object that comprises a tree and a house having a white background and a visible border. The second graphical object 510 is an annotation object that reads “This is a house” having a transparent background and border. The second graphical object 510 at least partially overlaps the first graphical object 500 and thus, the first and second graphical objects 500 and 510 are grouped. Since the first graphical object 500 is positioned behind or below the second graphical object 510, the first graphical object 500 is set as the parent graphical object and the second graphical object 510 is set as the child graphical object.

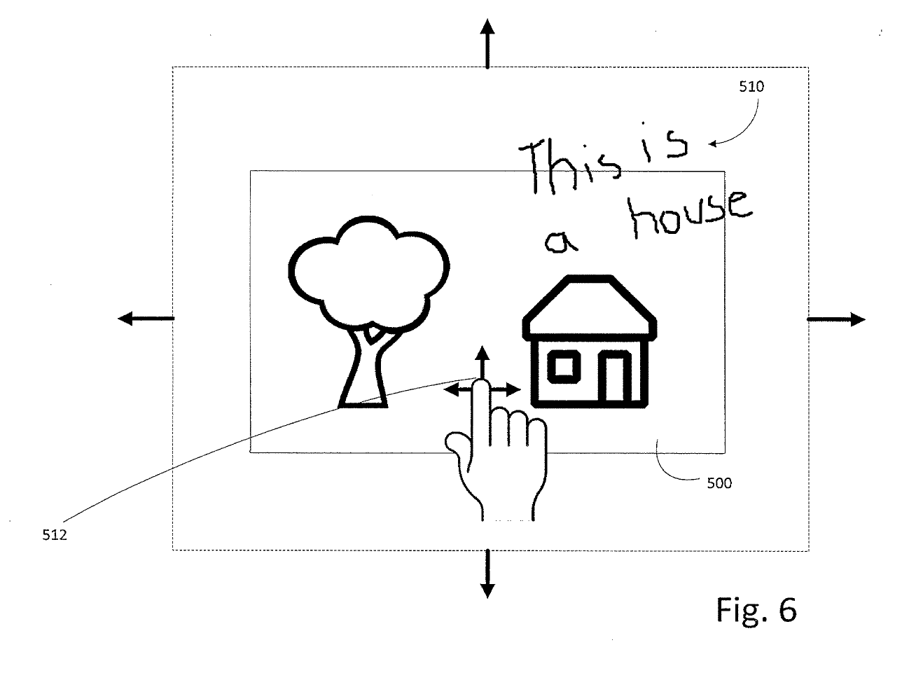

FIG. 6 shows an example of manipulating the first and second graphical objects 500 and 510 of FIG. 5. As can be seen, a user performs a movement gesture on the display surface 15 of the touch panel 14 starting at contact down position 512 on the first graphical object 500. The contact down position 512 falls within the boundaries of the first graphical object 500 but not the second graphical object 510. Since the first and second graphical objects 500 and 510 are grouped together, and the first graphical object 500 is the parent graphical object of the group, both the first and second graphical objects 500 and 510 are manipulated together according to the movement gesture.

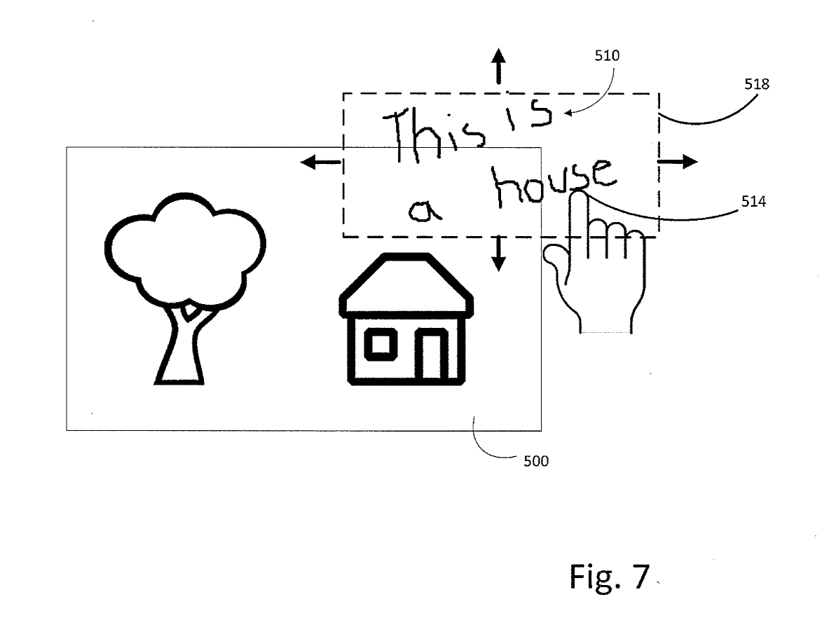

FIG. 7 shows an example of manipulating the second graphical object 510 of FIG. 5. As can be seen, a user performs a movement gesture on the display surface 15 of the touch panel 14 starting at contact down position 514 on the second graphical object 510. Since the second graphical object 510 is the child graphical object of the group, only the second graphical object 510 is manipulated according to the movement gesture.

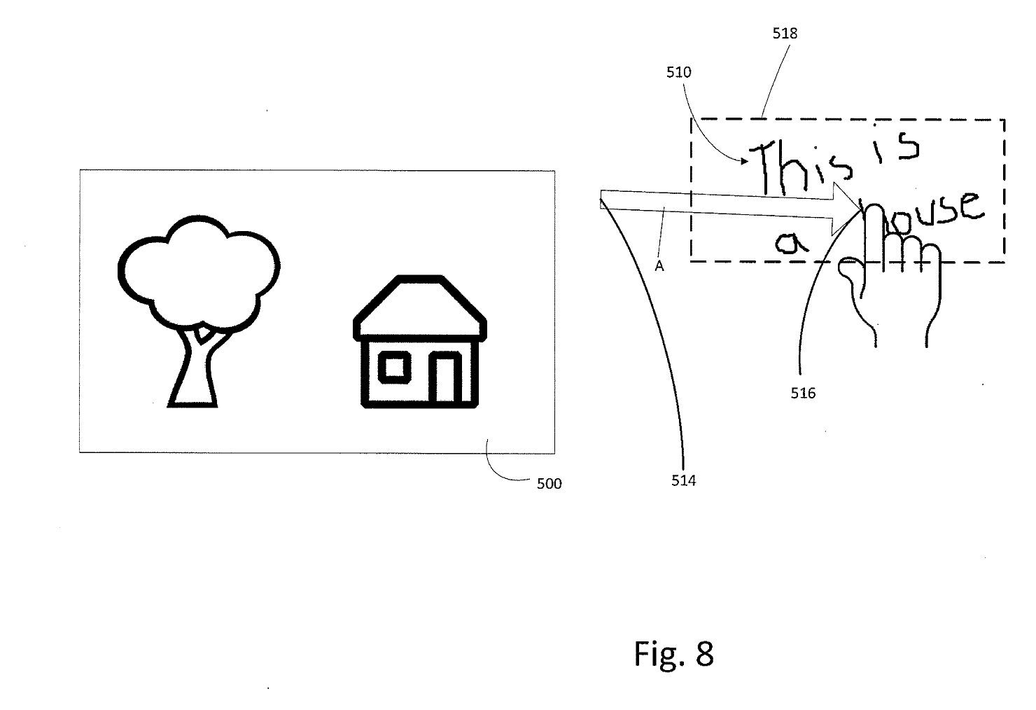

FIG. 8 shows an example of ungrouping the first and second graphical objects 500 and 510 of FIG. 5. As can be seen, a user performs a movement gesture on the display surface 15 of the touch panel 14, as indicated by arrow A, starting at contact down position 514 on the second graphical object 510 and ending at contact up position 516. Since the second graphical object 510 is the child graphical object of the group, only the second graphical object 510 is moved. The second graphical object 510 is moved to a location corresponding to contact up position 516. The second graphical object 510 no longer overlaps with the first graphical object 500 and as a result, the first and second graphical objects 500 and 510 are ungrouped.

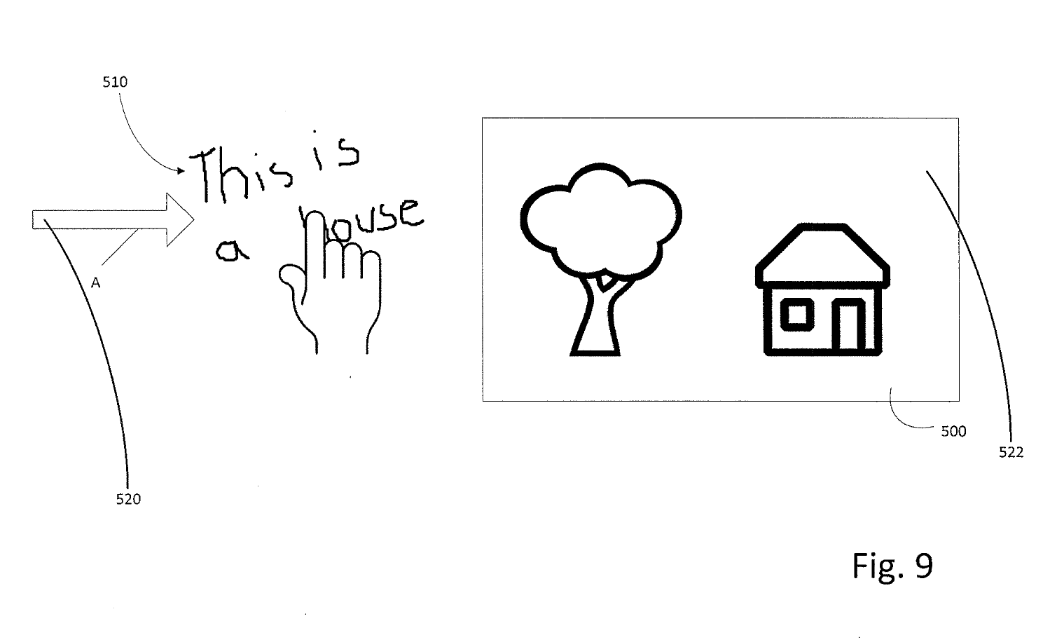

FIG. 9 shows an example of grouping the first and second graphical objects 500 and 510 based on another movement gesture. As can be seen, a user performs a movement gesture on the display surface 15 of the touch panel 14, as indicated by arrow A, starting at contact down position 520 on the second graphical object 510 and ending at contact up position 522. The second graphical object 510 is moved such that it overlaps with the first graphical object 500. As a result, the first and second graphical objects 500 and 510 are grouped.

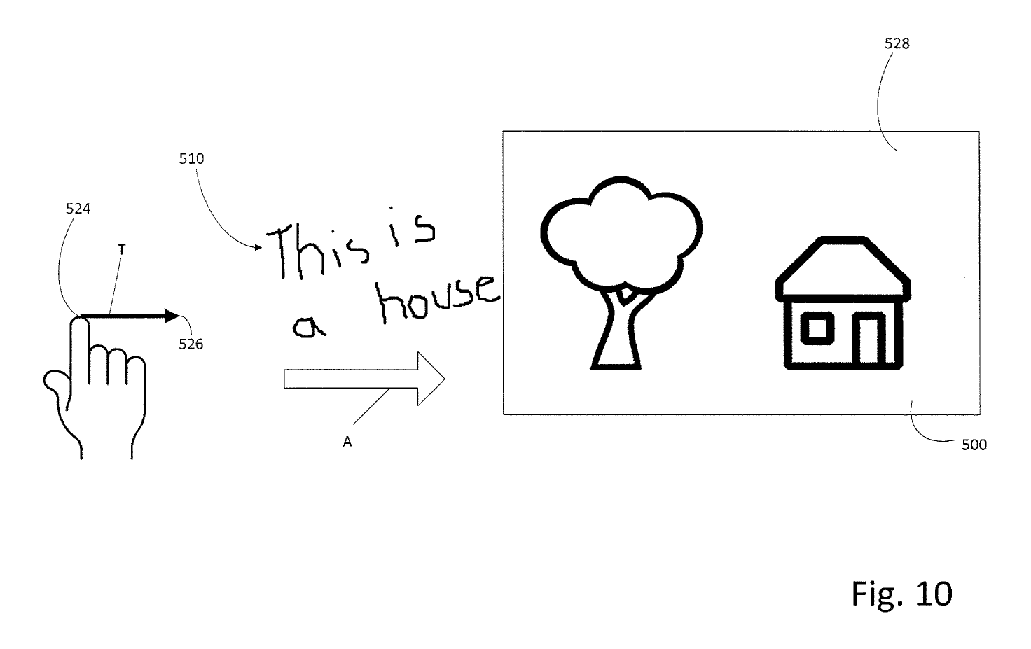

FIG. 10 shows an example of grouping the first and second graphical objects 500 and 510 based on a throwing gesture. As can be seen, a user performs a throwing gesture on the display surface 15 of the touch panel 14, as indicated by arrow T, starting at contact down position 524 on the second graphical object 510 and ending at contact up position 526. As a result, the second graphical object 510 travels towards the first graphical object 500, as indicated by arrow A, until it reaches final location 528. Since a portion of the second graphical object 510 overlaps with a portion of the first graphical object 500, the first and second graphical objects 500 and 510 are grouped.

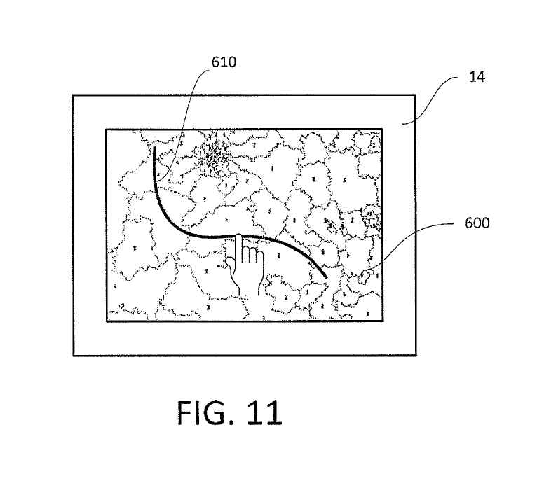

As described above, each graphical object comprises an event handler to perform the required manipulation based on gestures made by the user on the display surface 15 of the touch panel 14. As will be appreciated, this enables a third party application to be easily integrated with the Contact Event Monitor. An example is shown in FIG. 11. As can be seen, a graphical object in the form of a third party map 600 is displayed on the display surface 15 of the touch panel 14. A graphical object 610 in the form of an annotation is drawn on top of graphical object 600. Annotation graphical object 610 overlaps with the underlying map graphical object 600. As a result, graphical objects 600 and 610 are grouped together with graphical object 600 being set as the parent graphical object and graphical object 610 being set as the child graphical object. For example, if the user performs a pinch-out gesture or a pinch-in gesture on the display surface 15 of the touch panel 14, the Contact Event Monitor passes the resulting gesture data to the event handler of both graphical objects 600 and 610 resulting in each of graphical objects 600 and 610 being scaled as desired. As a result, the spatial relationship between the parent graphical object and child graphical object is maintained.

Although the gestures are described as being one of a movement gesture, a throwing gesture, a pinch-in gesture, a pinch-out gesture, a rotate gesture and a circle-and-tap gesture, those skilled in the art will appreciate that other types of gestures may be identified such as for example a swipe gesture and a pan gesture. Should a conflict occur based on the fact that more than one gesture may be identified based on the Contact Down, Contact Move and Contact Up events, those of skill in the art will appreciate that the conflict may be resolved by prioritizing the gestures such that, for example, a pan gesture is recognized only if a throwing gesture fails when sent to the event handler(s) of the graphical object(s). Of course other conflict resolution methods may be employed.

Although in embodiments described above each graphical object is described as comprising an event handler for processing gesture data, callback procedures may be used. In this case, each graphical object may register its event handler routine as a callback procedure with the Contact Event Monitor. In the event that a gesture is performed on the display surface 15 of the touch panel 14, the Contact Event Monitor calls the registered callback procedures or routines for each of the affected graphical objects. For example, in the event that a gesture is performed on the parent graphical object of a group, the callback routines of the parent graphical object and each child graphical object are called by the Contact Event Monitor such that each graphical object is manipulated.

In another embodiment, bindings may be used. In this embodiment, the event handlers of each graphical object may be bound to a function or routine that is provided, for example in a library, so that when the event handler is called, the corresponding bound library routine is used to process the gesture data.

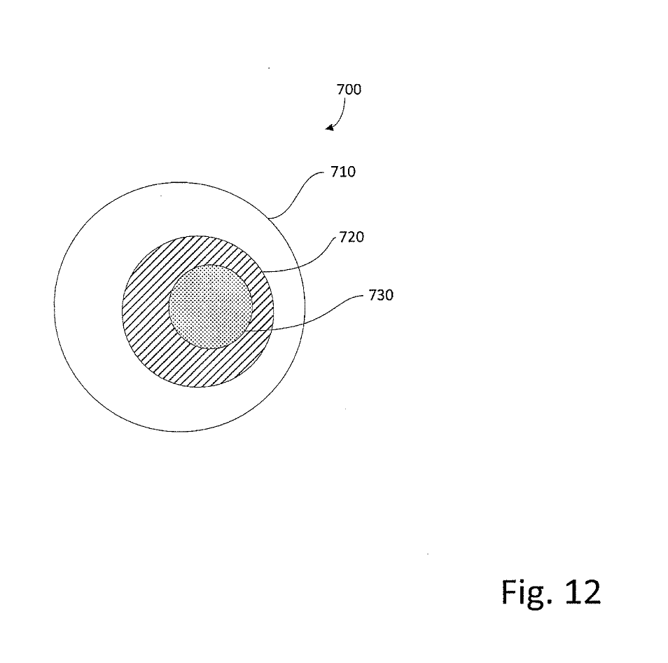

Although in embodiments described above, a group is defined as having a parent graphical object and one or more child graphical objects, those skilled in the art will appreciate that a group may have cascading relationships between several graphical objects. For example, a child graphical object may have its own child graphical objects (referred to as grandchild graphical objects). FIG. 12 shows a group that includes three graphical objects, namely a parent graphical object 710, a child graphical object 720, and a grandchild graphical object 730. The child graphical object 720 acts as the parent graphical object of the grandchild graphical object 730. Manipulation of the parent graphical object 710 results in manipulation of the parent graphical object 710, the child graphical object 720 and the grandchild graphical object 730. Manipulation of the child graphical object 720 results in manipulation of the child graphical object 720 and the grandchild graphical object 730. The parent graphical object 710 is not manipulated. Manipulation of the grandchild graphical object 730 results in manipulation of only the grandchild graphical object 730, that is, the parent graphical object 710 and the child graphical object 720 are not manipulated.

Although in embodiments described above, a group is created in the event that a graphical object overlaps with at least a portion of another graphic object, those skilled in the art will appreciate that a group may be created using other criteria. For example, in another embodiment a group is created in the event that a graphical object completely overlaps with another graphical object. In another embodiment, a group is created in the event that at least half of a graphical object overlaps with another graphical object. In another embodiment, the amount of overlap may be set by a user such that graphical objects are grouped only when the graphical objects overlap at least by a set percentage.

Although in embodiments described above the parent graphical object and child graphical object are described as being set based on relationship criteria wherein the parent graphical object is set as being the bottom graphical object and each child graphical object is set as overlying the parent graphical object, those skilled in the art will appreciate that other relationship criteria may be used. For example, in another embodiment, the parent graphical object may be set as being the larger graphical object and each child graphical object may be set as being a smaller graphical object. In another embodiment, graphical object types may be used to identify parent graphical objects and child graphical objects. For example, a graphical object in the form of an annotation or drawing may be set as always being a child graphical object and a graphical object in the form of an image, a metafile, a table or a video may be set as always being a parent graphical object. In another embodiment, multiple criteria may be used to set the parent graphical object and each child graphical object. For example, if the overlapping graphical objects have the same graphical object type, the parent graphical object may be set as being the larger graphical object and each child graphical object may be set as being a smaller graphical object. However, if the overlapping graphical objects have different graphical object types, the parent graphical object and child graphical object may be set based on their graphical object types, as described above.

Although in embodiments described, the step of determining if a graphical object overlaps with at least a portion of another graphical object is performed by comparing the borders of each graphical object, those skilled in the art will appreciate that alternatives are available. For example, in another embodiment this check may be performed by determining if any pixels contained within a graphical object correspond to the same pixel location on the display surface 15 of the touch panel 14 as a pixel contained within another graphical object.

Although in embodiments described above, the interactive input system is described as being in the form of a touch table, those skilled in the art will appreciate that the interactive input system may take other forms and orientations. For example, the interactive input system may employ machine vision, analog resistive, electromagnetic, capacitive, acoustic or other technologies to register input. The display surface may also take a vertical orientation and be mounted on a wall surface or the like or otherwise be suspended or supported in this orientation.

For example, the interactive input system may employ for example: an LCD screen with camera based touch detection (for example SMART Board™ Interactive Display—model 8070i); a projector-based interactive whiteboard (IWB) employing analog resistive detection (for example SMART Board™ IWB Model 640); a projector-based IWB employing a surface acoustic wave (WAV); a projector-based IWB employing capacitive touch detection; a projector-based IWB employing camera based detection (for example SMART Board™ model SBX885ix); a table (for example SMART Table™—such as that described in U.S. Patent Application Publication No. 2011/069019 assigned to SMART Technologies ULC of Calgary); a slate computer (for example SMART Slate™ Wireless Slate Model WS200); a podium-like product (for example SMART Podium™ Interactive Pen Display) adapted to detect passive touch (for example fingers, pointer, etc.—in addition to or instead of active pens); all of which are provided by SMART Technologies ULC of Calgary, Alberta, Canada.

Other devices that utilize touch interfaces such as for example tablets, smartphones with capacitive touch surfaces, flat panels having touch screens, track pads, interactive tables, and the like may embody the above described methods.

Those skilled in the art will appreciate that the host application described above may comprise program modules including routines, object components, data structures, and the like, embodied as computer readable program code stored on a non-transitory computer readable medium. The non-transitory computer readable medium is any data storage device that can store data. Examples of non-transitory computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion.

Although embodiments have been described above with reference to the accompanying drawings, those of skill in the art will appreciate that variations and modifications may be made without departing from the scope thereof as defined by the appended claims.

What is claimed is:

1. A method for grouping graphical objects, comprising:
presenting graphical objects on a display surface; and
in the event that the graphical objects at least partially overlap, grouping the graphical objects.

2. The method of claim 1 wherein during the grouping, the graphical objects are grouped according to a defined hierarchy.

3. The method of claim 2 wherein the grouping comprises:
identifying one of the graphical objects as a parent graphical object; and
identifying each other graphical object as a child graphical object associated with the parent graphical object.

4. The method of claim 3 further comprising manipulating one or more of the graphical objects.

5. The method of claim 4 wherein the manipulating is performed in response to a gesture performed on the display surface.

6. The method of claim 5 wherein in the event that the gesture is performed on the display surface at a location associated with the parent graphical object, the parent graphical object and child graphical object are both manipulated in accordance with the gesture.

7. The method of claim 6 wherein in the event that the gesture is performed on the display surface at a location associated with the child graphical object, only the child graphical object is manipulated according to the gesture in accordance with the gesture.

8. The method of claim 5 wherein each graphical object comprises an event handler configured to receive gesture data generated in response to the performed gesture and to manipulate the respective graphical object based on the received gesture data.

9. The method of claim 8 wherein in the event that the gesture is performed on the display surface at a location associated with the parent graphical object, gesture data is communicated to both the parent graphical object and the child graphical object.

10. The method of claim 9 wherein in the event that the gesture is performed on the display surface at a location associated with the child graphical object, gesture data is communicated only to the child graphical object.

11. The method of claim 3 further comprising:
ungrouping the parent graphical object and child graphical object in the event that the child graphical object is moved on the display surface to a location that is more than a threshold distance away from the parent graphical object.

12. The method of claim 3 wherein the parent graphical object and each child graphical object are identified based on relationship criteria.

13. The method of claim 12 wherein the relationship criteria is at least one of stacking order, graphical object size and graphical object type.

14. A non-transitory computer readable medium having stored thereon computer program code, which when executed by a computing device, performs a method comprising:
presenting graphical objects on a display surface; and
in the event that the graphical objects at least partially overlap, grouping the graphical objects.

15. An interactive input system comprising:
an interactive surface; and
processing structure communicating with the interactive surface and configured to:
cause graphical objects to be displayed on the interactive surface; and
in the event that the graphical objects at least partially overlap, group the graphical objects.

16. The interactive input system of claim 15 wherein the processing structure is configured to group the graphical objects according to a defined hierarchy.

17. The interactive input system of claim 16 wherein the processing structure, during grouping of the graphical objects, is configured to:
identify one of the graphical objects as a parent graphical object; and
identify each other graphical object as a child graphical object associated with the parent graphical object.

18. The interactive input system of claim 17 wherein the processing structure is further configured to manipulate the graphical objects.

19. The interactive input system of claim 18 wherein the processing structure is configured to manipulate the graphical objects in response to a gesture performed on the interactive surface.

20. The interactive input system of claim 19 wherein in the event that the gesture is performed on the touch surface at a location associated with the parent graphical object, the processing structure is configured to manipulate both the parent graphical object and the child graphical object in accordance with the gesture.

21. The interactive input system of claim 20 wherein in the event that the gesture is performed on the touch surface at a location associated with the child graphical object, the processing structure is configured to manipulate only the child graphical object in accordance with the gesture.

22. The interactive input system of claim 15 wherein the touch surface is in one of a horizontal and vertical orientation.

23. An apparatus comprising:
one or more processors; and
memory storing program code, the one or more processors communicating with said memory and configured to execute the program code to cause said apparatus at least to:
cause graphical objects to be displayed on an interactive surface; and
in the event that the graphical objects at least partially overlap, group the graphical objects.

24. The apparatus of claim 23 wherein the one or more processors are further configured to execute the program code to cause said apparatus to group the graphical objects according to a defined hierarchy.

25. The apparatus of claim 24 wherein the one or more processors are further configured to execute the program code to cause said apparatus to:
identify one of the graphical objects as a parent graphical object; and
identify each other graphical object as a child graphical object associated with the parent graphical object.

26. The apparatus of claim 25 wherein the one or more processors are further configured to execute the program code to cause said apparatus to manipulate the graphical objects.

27. The apparatus of claim 26 wherein the one or more processors are further configured to execute the program code to cause said apparatus to manipulate the graphical objects in response to a gesture performed on the interactive surface.

28. The apparatus of claim 27 wherein in the event that the gesture is performed on the interactive surface at a location associated with the parent graphical object, the one or more processors are further configured to execute the program code to cause said apparatus to manipulate both the parent graphical object and the child graphical object in accordance with the gesture.

29. The apparatus of claim 28 wherein in the event that the gesture is performed on the interactive surface at a location associated with the child graphical object, the one or more processors are further configured to execute the program code to cause said apparatus to manipulate only the child graphical object in accordance with the gesture.
